(19) United States
(12) Patent Application Publication
(10) Pub. No.: US 2017/0046592 A1
(43) Pub. Date: Feb. 16, 2017

(54) HMI System Based on A 3D TOTO Word Card

(71) Applicant: Xiaodong ZHOU, Shandong Province (CN)

(72) Inventor: Xiaodong ZHOU, Shandong Province (CN)

(21) Appl. No.: 15/091,538

(22) Filed: Apr. 5, 2016

(30) Foreign Application Priority Data
Aug. 11, 2015 (CN) 201520601881.2

(51) Int. Cl. G06K 9/62; G09B 19/06; G06K 9/46

(52) U.S. Cl. CPC G06K 9/6202; G06K 9/4609; G06K 9/4652; G09B 19/06; G06K 2209/011

(57) ABSTRACT

The utility model relates to a HMI system based on a 3D TOTO word card, comprising a verification activation module, a scanning module, a identification module, a matching module, a display module, a camera module, a help module, a interaction module, a storage module, a sharing module and a CPU. The scanning module comprises a single-card scanning module, a combined scanning module and an experience scanning module. The verification activation module, scanning module, identification module, matching module, display module, camera module, help module, interaction module, storage module and share module are connected with CPU, respectively. The utility model increases children's practical ability in the cognitive process of Chinese characters and improves Children's participation in the cognitive process of Chinese characters, thus improving Childeren's efficiency and fun of cognition of Chinese characters; in addition, when entering the system, the customers need to get a verification code from the merchant, and activate the system by verification activation module, to facilitate the merchant to provide customers with other follow-up services, such as notification sending or password extracting.

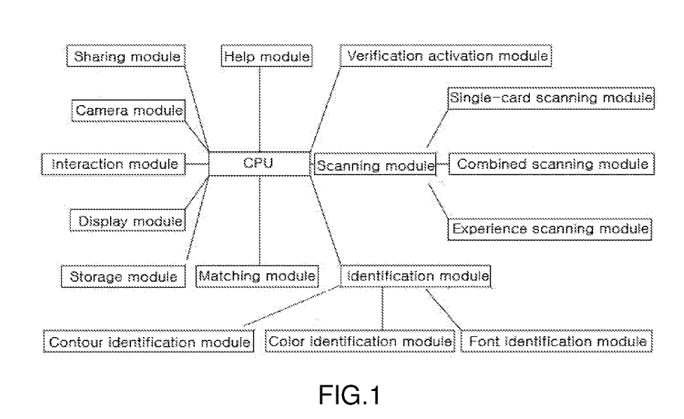

### BACKGROUND OF THE INVENTION

The utility model relates to a HMI system based on a 3D TOTO word card.

The existing word card systems just simply scan the Chinese characters in a picture and display the scanned information. In the process, children just see the cards and the information displayed from Chinese characters and they haven't practically written any characters, resulting in lengthening their cognitive process of Chinese characters are lengthened; not fully participating in the process of cognition of Chinese characters; lacking of Children's practical ability in the cognitive process of Chinese characters; weakening Children's efficiency and fun of cognition of Chinese characters; in addition, since the existing systems has no verification activation function, and the scanning runs when its program is started, the merchant lake of the capabilities of providing customers with follow-up services.

### BRIEF SUMMARY OF THE INVENTION

To make up for deficiencies of the existing technologies, the utility model provides a HMI system based on a 3D TOTO word card. By increasing the word coating process, it increases children's practical ability in the cognitive process of Chinese characters and improves Children's participation in the cognitive process of Chinese characters, thus improving Childeren's efficiency and fun of cognition of Chinese characters; in addition, when entering the system, the customers need to get a verification code from the merchant, and activate the system by verification activation module, to facilitate the merchant to provide customers with other follow-up services, such as notification sending or password extracting. The problems in the exsiting technologies are solved by the utility model.

The technical scheme of the utility model for solving the technical problem is that:

A HMI system based on a 3D TOTO word card comprises a verification activation module, a scanning module, a identification module, a matching module, a display module, a camera module, a help module, a interaction module, a storage module, a sharing module and a CPU. The scanning module comprises a single-card scanning module, a combined scanning module and an experience scanning module. The verification activation module, scanning module, identification module, matching module, display module, camera module, help module, interaction module, storage module and share module are connected with CPU, respectively.

The identification module comprises a contour identification module, a color identification module and a font identification module. The contour identification module is used for contour identification of the font on the 3D TOTO word card, and genertation of contour identification information; color recognition module is used for color identification of the font on the 3D TOTO word card, and genertation of color identification information; font identification module is used for font identification by matching of the contour identification information and the color identification information with the identification information in the identification library.

The matching module matches the corresponding subject and scene based on the font identified by identification module.

By adopting the technical scheme and increasing the word coating process, the utility model increases children's practical ability in the cognitive process of Chinese characters and improves Children's participation in the cognitive process of Chinese characters, thus improving Childeren's efficiency and fun of cognition of Chinese characters; in addition, when entering the system, the customers need to get a verification code from the merchant, and activate the system by verification activation module, to facilitate the merchant to provide customers with other follow-up services, such as notification sending or password extracting.

### BRIEF DESCRIPTION OF THE DRAWINGS

DWG 3 is a structure diagram of the utility model.

### DETAILED DESCRIPTION OF THE INVENTION

To clearly explain the technical characteristics of the technical scheme, the following specific embodiment is given by combining with a drawing to further elaborate the details of the utility model.

As shown in DWG 1, a HMI system based on a 3D TOTO word card, comprising a verification activation module, a scanning module, a identification module, a matching module, a display module, a camera module, a help module, a interaction module, a storage module, a sharing module and a CPU. The scanning module comprises a single-card scanning module, a combined scanning module and an experience scanning module. The verification activation module, scanning module, identification module, matching module, display module, camera module, help module, interaction module, storage module and share module are connected with CPU, respectively.

The identification module comprises a contour identification module, a color identification module and a font identification module. The contour identification module is used for contour identification of the font on the 3D TOTO word card, and genertation of contour identification information; color recognition module is used for color identification of the font on the 3D TOTO word card, and genertation of color identification information; font identification module is used for font identification by matching of the contour identification information and the color identification information with the identification information in the identification library.

The matching module matches the corresponding subject and scene based on the font identified by identification module.

When using, write along the contour of Chinese characters on the 3D TOTO Word Card with color pens, and turn on the main interface of the system, click experience scanning module to skip to an experience scanning scene interface, wherein 3D TOTO word card are two cards selected from each category of a plurality of categories and displayed in 3D animation. Click the single-card scanning module on the main interface to skip to a single-card scanning module scene interface, the coated font on the 3D TOTO word cards are scanned by single-card scanning module any information can't be scanned if the font on the card has not been coated with color pens, in order to prompt children to coat the word, then scan and transmit the scan information to identification module by CPU; the corresponding information on 3D TOTO word card are identified by contour identification module, color identification module and font identification module in the identification module, respectively; and the identified information is transmitted to the matching module by CPU; then when the information which is transmitted from CPU is received by matching module, it is matched with the information previously stored in the storage module by CPU; the corresponding information in the storage module is picked after the matching is succeeded; the picked information is transmitted to display module by CPU and displayed in 3D animation by CPU. Click the combined scanning module on main interface, a single card scanning module to skip to single-card scanning module scene interface, and the font on two coated 3D TOTO word cards are scanned by scanning module, and then the scanned information is transmitted to the identification module by CPU, the corresponding information on combined 3D TOTO word card are identified by contour identification module, color identification module and font identification module in the identification module, respectively; and the identified information is transmitted to the matching module by CPU; then when the information which is transmitted from CPU is received by matching module, it is matched with the information previously stored in the storage module by CPU. the corresponding information in the storage module is picked after the matching is succeeded; the picked information is transmitted to display module by CPU and displayed in 3D animation by CPU; the information displayed on the display module can be photographed by camera module, and the information captured by camera module are stored into the store module by CPU and shared by share module. During operation, the corresponding help information can be captured by share module; by increasing the word coating process, it increases children's practical ability in the cognitive process of Chinese characters and improves Children's participation in the cognitive process of Chinese characters, thus improving Childeren's efficiency and fun of cognition of Chinese characters; in addition, when entering the system, the customers need to get a verification code from the merchant, and activate the system by verification activation module, to facilitate the merchant to provide customers with other follow-up services, such as notification sending or password extracting.

The specific embodiments described above cannot define the scope of protection of the utility model. For the technical staff in the invention, any possible change or replacement of the present invention belongs to the scope of protection of the utility model.

The details not described in the utility model are known to the technical staff in the invention.

What is claimed is:

1. A HMI system based on a 3D TOTO word card is characterized in that: comprising a verification activation module, a scanning module, a identification module, a matching module, a display module, a camera module, a help module, a interaction module, a storage module, a sharing module and a CPU. The scanning module comprises a single-card scanning module, a combined scanning module and an experience scanning module. The verification activation module, scanning module, identification module, matching module, display module, camera module, help module, interaction module, storage module and share module are connected with CPU, respectively.

2. The HMI system based on a 3D TOTO word card of claim 1 is characterized in that: The identification module comprises a contour identification module, a color identification module and a font identification module. The contour identification module is used for contour identification of the font on the 3D TOTO word card, and genertation of contour identification information; color recognition module is used for color identification of the font on the 3D TOTO word card, and genertation of color identification information; font identification module is used for font identification by matching of the contour identification information and the color identification information with the identification information in the identification library.

3. The HMI system based on a 3D TOTO word card is characterized in that: The matching module matches the corresponding subject and scene based on the font identified by identification module.
